(19) United States
(12) Patent Application Publication
(10) Pub. No.: US 2024/0127457 A1
(43) Pub. Date: Apr. 18, 2024

(54) LAYOUT-AWARE BACKGROUND GENERATING SYSTEM AND METHOD

(71) Applicant: Adobe Inc., San Jose, CA (US)

(72) Inventors: Sanyam JAIN, Delhi (IN); Rishav AGARWAL, Siliguri (IN); Gunjan BHUTANI, Delhi (IN)

(21) Appl. No.: 17/965,522

(22) Filed: Oct. 13, 2022

(51) Int. Cl. G06T 7/194; G06T 7/90; G06V 10/56; G06V 10/75

(52) U.S. Cl. CPC G06T 7/194; G06T 7/90; G06V 10/56; G06V 10/751; G06T 2207/10024; G06T 2207/20081

(57) ABSTRACT

Embodiments described herein include aspects related to generating a layout-aware background image. Aspects of the method include receiving a training dataset comprising a document. The method further includes obtaining a mask image based on a layout of content in the document, the mask image having a content area corresponding to content of the document. The method further includes training a machine learning model using the mask image to provide a trained machine learning model that generates transparency values for pixels of a background image for the document.

### BACKGROUND

Backgrounds are of a fundamental importance in the composition of any document. Background images can provide an added visual depth to the document and enhance the look and feel of a document. The cliché that a picture is worth a thousand words holds true because backgrounds can complement the content in a document by conveying the essence of the content through colors, designs, or the like. Picking the right background image for a document is essential because the right background images can make the document visually appealing and/or allow for better visibility of content in the document. Background images can also set the tone for the document. For example, a magazine aimed towards younger children will look better with a colorful background using bright colors such as yellow, blues, red, or the like. The same bright color tones from a children's magazine would not work for a business magazine.

### SUMMARY

Embodiments of the present disclosure related to, among other things, a system and method to efficiently and effectively generate layout-aware backgrounds based on awareness of a layout. In particular, in embodiments described herein, a layout-aware background generating system generates a mask image that indicate regions of visibility in the document. In the mask image, the regions of visibility are designated as white regions and the other areas are designated as black regions.

Further, in embodiments described herein, the layout-aware background generating system provides the mask image to a layout-aware machine learning model to train the model for generating a layout-aware background. The layout-aware background generating system uses an image generating algorithm with a modified Root Mean Square (RMS) loss function that forces the model to predict the value of 1 (indicating white) for the pixels in the regions requiring visibility and the allows the model to predict any value for the pixels outside of the regions requiring visibility. The image generator with modified RMS loss function allows the regions requiring visibility to be white so that the content can be visible in those areas and allow the rest of the regions to have an abstract background that is visually appealing. In one example, the layout-aware background generating system allows the generated background image to be smooth. In order to make the generated background image smooth, the value between the foreground and background regions does not change suddenly. Since the network can be continuous and differentiable, sampling the network on two different very close points leads to a very similar output value. This can ensure that there is no sudden transitions between the foreground and background regions and the resulting images have very smooth transitions. The smoothness of the generated background image allows the background image to have a beautiful effect of the abstract art. Therefore, the layout-aware background image generated has a uniqueness to it but has been designed while being aware of the content of the document. The layout-aware background image can be generated after multiple iterations through the model. Multiple iterations allow the model to generate a layout-aware background image that is close to the mask image. In one embodiment, the image generator with modified RMS loss function can produce multiple images that can be combined to make a video that can be used as a layout-aware background image.

The layout-aware background generating model is used to predict alpha values by subtracting the final value predicted for each pixel by 1 since less intense values are preferred around the regions of visibility and then multiplied by 255 to get a value in the Alpha channel range. This can be used to add transparency to an RGB image creating an RGBA layout-aware background image using Red Green Blue (RGB) values. In one example, a pixel with an alpha value of one allows the pixel to be opaque and a pixel with an alpha value of zero allows the pixel to be transparent. For example, a pixel with an alpha value of one allows the pixel to be completely opaque and a pixel with an alpha value of zero allows the pixel to be completely transparent. When pixels in an image are transparent, the background pixels or colors show through in regions where the pixel has alpha value of 0 (zero).

In one example, after adding a particular colored background to an RGBA image, the RGBA image is converted into a simple RGB image or an RGBA image with alpha value of 1 (one) at every pixel location. In another example, after adding a particular colored background to an RGBA image, the RGBA image is converted into a simple RGB image or an RGBA image with alpha value of 1 (one) at some pixel locations.

The RGB values can be modified based on different factors such as the type of content, the theme of the document, the demographics of the target audience, the demographic and location of the user viewing the document, the time of the day for the user viewing the document, or the like to determine the color schemes to use in the layout-aware background image. The user can modify the color of the background image and can also modify the mask image of the document. The layout-aware background image is combined with the document and the document is then presented to the user.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a diagram of an environment that can be used to perform the layout-aware background image generating method, according to embodiments of the present disclosure.

FIG. 2 provides an example layout-aware background generating system, in accordance with embodiments described herein.

FIG. 3 is a flow diagram illustrating an exemplary method for implementing preview and capture of stroke outlines in accordance with one embodiment of the present disclosure.

FIG. 4 are exemplary images illustrating an aspect in accordance with one embodiment in accordance with one embodiment of the present disclosure.

FIG. 5 are exemplary generated background images illustrating an aspect in accordance with one embodiment in accordance with one embodiment of the present disclosure.

FIG. 6 are exemplary generated background images illustrating an aspect in accordance with one embodiment in accordance with one embodiment of the present disclosure.

FIG. 7 is an exemplary operating environment for implementing embodiments of the present technology.

### DETAILED DESCRIPTION

Backgrounds are typically chosen that enhance the document and complement the content of the document. However, locating and identifying the suitable background for a document is difficult and time consuming. A user has to search through and review backgrounds from different sources. When the user manually locates a suitable background, the user may have to manually modify the background to ensure that the background does not interfere with the visibility of the contents in the document. This may entail analyzing the layout of content in the document and manually modifying portions of the background image that coincide with the areas of content in the document. For example, if there are portions of the background that are interfering with the content of the document by making the content hard to read or see, the designer would have to manually edit areas of the background to match up with the areas of the document that have content so that the content is visible. This may also entail changing the color of portions in the background image that coincide with the areas of content in the document or erasing the background image in those portions or the like. The edits can be done manually using software such as Adobe® Photoshop® to modify the background. The document may be any electronic file that may or may not include any content (for e.g. pdf document, word document, image, website, social media page, or the like). Contents in a document include, but are not limited to, images, text, symbols, or the like. Therefore, having a customized background image that is generated based on the document is beneficial. For example, having a customized background image generated based on the content of the document, the layout of content, or the like is beneficial. However, conventional implementations do not offer such a solution. Conventional systems that generate images such as CPPN and GAN can generate background images. However, these images are random. Images generated by conventional methods do not generate a background based on the layout of content in the document or image.

Accordingly, embodiments of the present disclosure are directed to employing techniques for efficiently and effectively generating layout-aware backgrounds based on awareness of the document such as awareness of the layout of content, the essence of the content, the theme of the content or document, the target audience, the demographic and/or location of the user viewing the document, the time of the day the user is viewing the document, current social, cultural, and/or political mood of the community in the area where the user live or the like.

In particular, in embodiments described herein, a layout-aware background generating system generates a mask image that indicates regions requiring visibility in the document. The regions requiring visibility in the document could include regions of visibility in the document or could include regions of visibility with an offset or could include any region in the document that may partially include content. In the mask image, the regions requiring visibility are designated as white regions and the areas outside of the regions of visibility are designated as black regions. Further, in embodiments described herein, the layout-aware background generating system provides the mask image to a layout-aware machine learning model to train the model for generating a layout-aware background image. The layout-aware background generating system can further adjust the mask image or the layout-aware background image based on user feedback or the system aligning the layout-aware background image with the user's preferences based on different factors such as learned behaviors or the like.

In more detail of the method to generate a layout-aware background image, a document is initially obtained. The document can be any electronic file that may or may not include content. A mask image is then obtained that indicates regions that require a visibility in the document. Different regions in the mask image could indicate different levels of visibility requirement. For example, in the regions that include a border around a page in the document could require a lower visibility and regions that include text could require a higher visibility. In one embodiment, the mask image designates the regions requiring visibility as white regions and the area of the document outside those regions as black regions. Any other value, color, or designation system can be used to designate the different regions in the mask image. The mask image is then provided to a layout-aware machine learning model to train the model for generating a layout-aware background image.

In one embodiment, the layout-aware machine learning model uses a modified image generating tool such as a CPPN network with modified RMS loss function or a GAN with a modified RMS loss function to generate a layout-aware background image. In one embodiment, the image generator with modified RMS loss function uses a modified CPPN network with a modified Root Mean Square (RMS) loss function that forces the model to predict the value of 1 (indicating complete transparency) for the pixels in the regions requiring visibility and the allows the model to predict any value for the pixels outside of the regions requiring visibility. This allows the regions outside visibility to be random designs that looks smooth and flow slightly into the regions requiring visibility. The image generator with modified RMS loss function allows the regions requiring visibility to be white so that the content can be visible in those areas and allow the rest of the regions to have an abstract background that is visually appealing. Therefore, the layout-aware background image generated has a uniqueness to it but has been designed while being aware of the content of the document. The layout-aware background image can be generated after multiple iterations through the model. Multiple iterations allow the model to generate a layout-aware background image that is close to the mask image. For example, after multiple iterations through the model, the layout-aware background image starts to look similar to the mask image where the regions requiring visibility in the document are almost similar to the regions requiring visibility in the mask image. In one embodiment, the image generator with modified RMS loss function can produce multiple images that can be combined to make a video that can be used as a layout-aware background image. In one example, the generated layout-aware background image that is a video will look like smooth flow of art in the background of the document and the layout-aware background image can be designed so that it is not too loud but moves smoothly and slowly with less loud design so that it doesn't distract the user viewing the document.

The layout-aware background generating model is used to predict alpha values by subtracting the final value predicted for each pixel by 1 since less intense values are preferred around the regions of visibility and then multiplied by 255 to get a value in the Alpha channel range. This can be used to add transparency to an RGB image creating an RGBA layout-aware background image using Red Green Blue (RGB) values. In one example, a pixel with an alpha value of one allows the pixel to be opaque and a pixel with an alpha value of zero allows the pixel to be transparent. For example, a pixel with an alpha value of one allows the pixel to be completely opaque and a pixel with an alpha value of zero allows the pixel to be completely transparent. When pixels in an image are transparent, the background pixels or colors show through in regions where the pixel has alpha value of 0 (zero). In order to add a particular colored background to the RGBA image, the following equations can be used to convert from RGBA to RGB:

Target.R=((1−Source.A)*BGColor.R)+(Source.A*Source.R) Equation (1)

Target.G=((1−Source.A)*BGColor.G)+(Source.A*Source.G) Equation (2)

Target.B=((1−Source.A)*BGColor.B)+(Source.A*Source.B) Equation (3)

In one example, after adding a particular colored background to an RGBA image, the RGBA image is converted into a simple RGB image or an RGBA image with alpha value of 1 (one) at every pixel location. In another example, after adding a particular colored background to an RGBA image, the RGBA image is converted into a simple RGB image or an RGBA image with alpha value of 1 (one) at some pixel locations.

The RGB values can be modified based on different factors such as the type of content, the theme of the document, the demographics of the target audience, the demographic and location of the user viewing the document, the time of the day for the user viewing the document, or the like to determine the color schemes to use in the layout-aware background image. In another example, multiple color schemes can be used in the layout-aware background image. For example, for a document that contains content related to Christmas, the layout-aware background image can contain light green color in the regions requiring visibility and a mix of different shades of green and red in the areas outside the regions requiring visibility. The user can modify the color of the background image and can also modify the mask image of the document. The layout-aware background image is combined with the document and the document is then presented to the user.

Some of the advantages of the layout-aware background generating system and method include efficiently and effectively generating layout-aware backgrounds based on awareness of the document. The layout-background generating system and method generates background images that allow the content of the document to be visible, therefore allowing for an easier readability of the content of the document. The layout-background generating system generates background images that highlight the content of the document in an efficient and effective manner. As such, the generated background images are generated by the layout-aware background generating system and method using an awareness of the layout of content. Different factors such as the essence of the content, the theme of the content or document, the target audience, the demographic and/or location of the user viewing the document, the time of the day the user is viewing the document, current social, cultural, and/or political mood of the community in the area where the user live or the like can be used to further customize the generated background image. The layout-aware background generating system and method allows the user to further adjust the generated background image or further align the generated background to user's preferences based on different factors such as learned behaviors or the like.

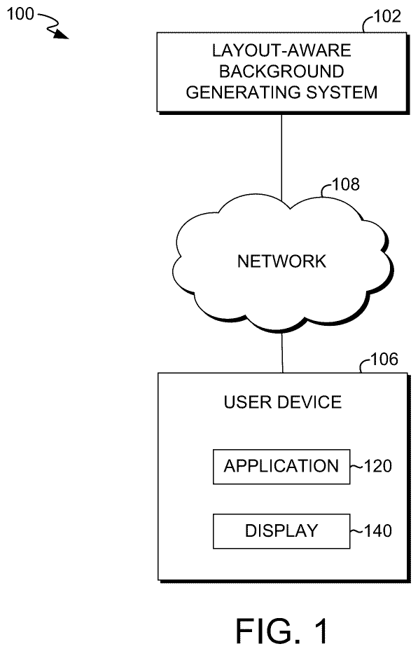

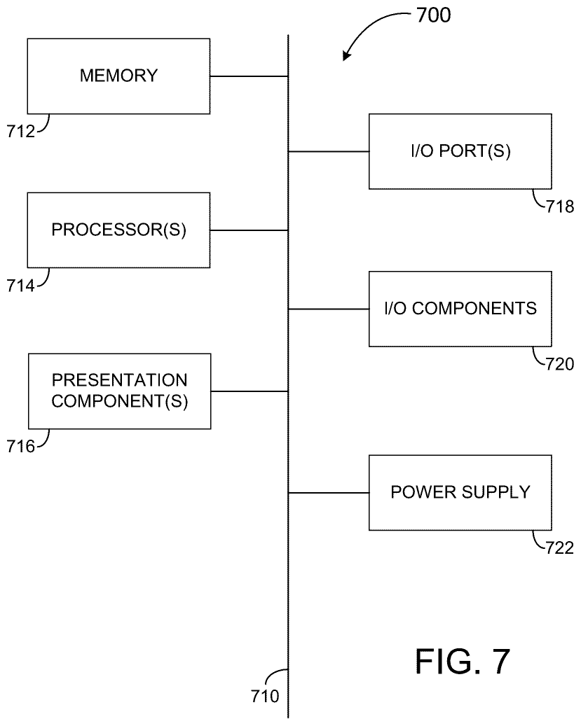

Turning to FIG. 1, FIG. 1 is a diagram of an environment 100 that can be used to perform the layout-aware background image generating method, according to embodiments of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 7.

The system 100 is an example of a suitable architecture for implementing certain aspects of the present disclosure. In one embodiment, the system 100 includes, among other components not shown, a layout-aware background generating system 102, and a user device 106. Each of the layout-aware background generating system 102 and user device 106 shown in FIG. 1 can comprise one or more computer devices, such as the computing device 700 of FIG. 7 discussed below. The layout-aware background generating system 102 may be embodied at least partially by the instructions corresponding to application 120. Therefore, the layout-aware background generating system 102 can operate on a server or on a user device, such as user device 106, or partially on multiple devices. As shown in FIG. 1, the layout-aware background generating system 102 and the user device 106 can communicate via a network 108, which may include, without limitation, one or more local area networks (LANs) and/or wide area networks (WANs). Such networking environments are commonplace in offices, enterprise-wide computer networks, intranets, and the Internet. It should be understood that any number of user devices and layout-aware background generating systems may be employed within the system 100 within the scope of the present disclosure. Each may comprise a single device or multiple devices cooperating in a distributed environment. For instance, the layout-aware background generating system 102 could be provided by multiple devices collectively providing the functionality of the layout-aware background generating system 102 as described herein. Additionally, other components not shown may also be included within the network environment.

It should be understood that any number of user devices 106, layout-aware background generating systems 102, and other components can be employed within the operating environment 100 within the scope of the present disclosure. Each can comprise a single device or multiple devices cooperating in a distributed environment.

User device 106 can be any type of computing device capable of being operated by a user. For example, in some implementations, user device 106 is the type of computing device described in relation to FIG. 7. By way of example and not limitation, a user device 106 may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 106 can include one or more processors, and one or more computer-readable media. The computer-readable media may include computer-readable instructions executable by the one or more processors. The instructions may be embodied by one or more applications, such as application 120 shown in FIG. 1. Application 120 is referred to as a single application for simplicity, but its functionality can be embodied by one or more applications in practice. As indicated above, the other user devices can include one or more applications similar to application 120.

The application(s) may generally be any application capable of facilitating generation of the layout-aware background image (e.g., via the exchange of information between the user devices and the layout-aware background generating system 102). In some implementations, the application(s) comprises a web application, which can run in a web browser, and could be hosted at least partially on the server-side of environment 100. In addition, or instead, the application(s) can comprise a dedicated application, such as an application having image processing functionality. In some cases, the application is integrated into the operating system (e.g., as a service). It is therefore contemplated herein that “application” be interpreted broadly.

In accordance with embodiments herein, the application 120 can either initiate the layout-aware background generating system 102 to facilitate layout-aware background image generating method via a set of operations initiated to generate the layout-aware background image and display the generated layout-aware background image on a display 140 or display the document combined with the generated layout-aware background image on the display 140.

In embodiments, the layout-aware background generating system 102 obtains a document for processing by the layout-aware background generating system 102. In particular, the layout-aware background generating system 102 performs various processes to generate a layout-aware background image, in accordance with embodiments described herein. At a high level, and as described in more detail herein, the layout-aware background generating system 102 obtains a mask image of the document. The mask image indicates regions that require a visibility in the document. The mask image is then provided to a layout-aware machine learning model to train the model for generating a layout-aware background image.

In one embodiment, the layout-aware machine learning model uses an image generator with modified RMS loss function with a modified Root Mean Square (RMS) loss function that forces the model to predict the value of 1 (indicating complete transparency) for the pixels in the regions requiring visibility and the allows the model to predict any value for the pixels outside of the regions requiring visibility. The layout-aware background image generated using the image generator with modified RMS loss function allows the regions requiring visibility to be transparent so that the content can be visible in those areas and allow the rest of the regions to have an abstract background that is visually appealing. The layout-aware background image can be generated after multiple iterations through the model if the user prefers the generated layout-aware background image to be similar to the mask image. In one embodiment, the image generator with modified RMS loss function can produce multiple images that can be combined to make a video that can be used as a layout-aware background image that is smooth so that it doesn't distract the user viewing the document. The layout-aware background generating model is used to predict alpha values by subtracting the final value predicted for each pixel by 1 since less intense values are preferred around the regions of visibility and then multiplied by 255 to get a value in the Alpha channel range. This can be used to add transparency to an RGB image creating an RGBA layout-aware background image using Red Green Blue (RGB) values. In one example, a pixel with an alpha value of one allows the pixel to be opaque and a pixel with an alpha value of zero allows the pixel to be transparent. For example, a pixel with an alpha value of one allows the pixel to be completely opaque and a pixel with an alpha value of zero allows the pixel to be completely transparent. When pixels in an image are transparent, the background pixels or colors show through in regions where the pixel has alpha value of 0 (zero). In order to add a particular colored background to the RGBA image using equations (1)-(3) can be used. In one example, after adding a particular colored background to an RGBA image, the RGBA image is converted into a simple RGB image or an RGBA image with alpha value of 1 (one) at every pixel location. In another example, after adding a particular colored background to an RGBA image, the RGBA image is converted into a simple RGB image or an RGBA image with alpha value of 1 (one) at some pixel locations.

The RGB values can be modified based on different factors such as user's input and/or preference, the type of content, the theme of the document, the demographics of the target audience, the demographic and location of the user viewing the document, the time of the day for the user viewing the document, or the like. The user can modify the color of the background image and can also modify the mask image of the document. The layout-aware background image is combined with the document and the document is then presented to the user.

For cloud-based implementations, the instructions on layout-aware background generating system 102 may implement one or more aspects of the layout-aware background generating system 102, and application 120 may be utilized by a user and/or system to interface with the functionality implemented on server(s) 204. In some cases, application 120 comprises a web browser. In other cases, layout-aware background generating system 102 may not be required. For example, the functionality described in relation to the layout-aware background generating system 102 can be implemented completely on a user device, such as user device 106.

These components may be in addition to other components that provide further additional functions beyond the features described herein. The layout-aware background generating system 102 can be implemented using one or more devices, one or more platforms with corresponding application programming interfaces, cloud infrastructure, and the like. While the layout-aware background generating system 102 is shown separate from the user device 106 in the configuration of FIG. 1, it should be understood that in other configurations, some or all of the functions of the layout-aware background generating system 102 can be provided on the user device 106.

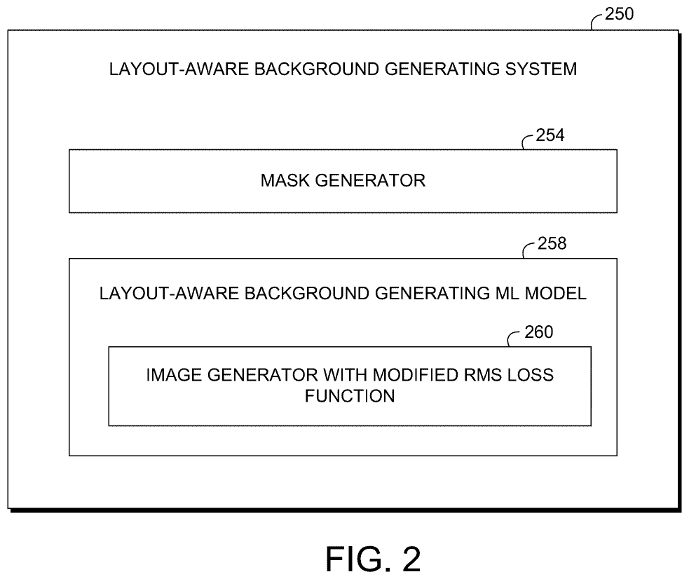

Turning to FIG. 2, FIG. 2 provides an example layout-aware background generating system 250. As shown, example layout-aware background generating system 250 includes a mask generator 254 and a layout-aware background generator Machine Learning (ML) model 258. The layout-aware background generator (ML) model 258 includes a modified image generator such as an image generator with modified RMS loss function 260. As can be appreciated, any number of components may be used to perform the various functionalities described herein.

In accordance with an embodiment, the layout-aware background generating system 250 obtains a document. The layout-aware background generating system 250 obtains a mask image for the document that indicates the regions requiring visibility. In one embodiment, the layout-aware background generating system 250 could use a mask generator 254 to generate the mask image. In other embodiments, the layout-aware background generating system 250 obtains the mask image for the document from another process, software, use, system or the like. The mask image is provided to the layout-aware background generating ML model 258 to generate a layout-aware background image.

The layout-aware background generating ML model 258 uses a modified image generator such as an image generator with modified RMS loss function 260 to generate a layout-aware background image. The image generator with modified RMS loss function 260 uses a modified Root Mean Square (RMS) loss function that forces the model to predict the value of 1 (indicating transparency) for the pixels in the regions requiring visibility and the allows the model to predict any value for the pixels outside of the regions requiring visibility. The image generator with modified RMS loss function 260 allows the regions in the background image requiring visibility to be transparent so that the content can be visible in those areas and allow the rest of the regions in the background image to have an abstract background that is visually appealing. The layout-aware background image can be generated after multiple iterations through the model if the user prefers the generated layout-aware background image to be similar to the mask image. In one embodiment, the image generator with modified RMS loss function 260 can produce multiple images that can be combined to make a video that can be used as a layout-aware background image that is smooth so that it doesn't distract the user viewing the document. Colors can be added to the layout-aware background image based on different factors such as user's input and/or preference, the type of content, the theme of the document, the demographics of the target audience, the demographic and location of the user viewing the document, the time of the day for the user viewing the document, or the like. The user can modify the color of the background image and can also modify the mask image of the document. The layout-aware background image is combined with the document and the document is then presented to the user.

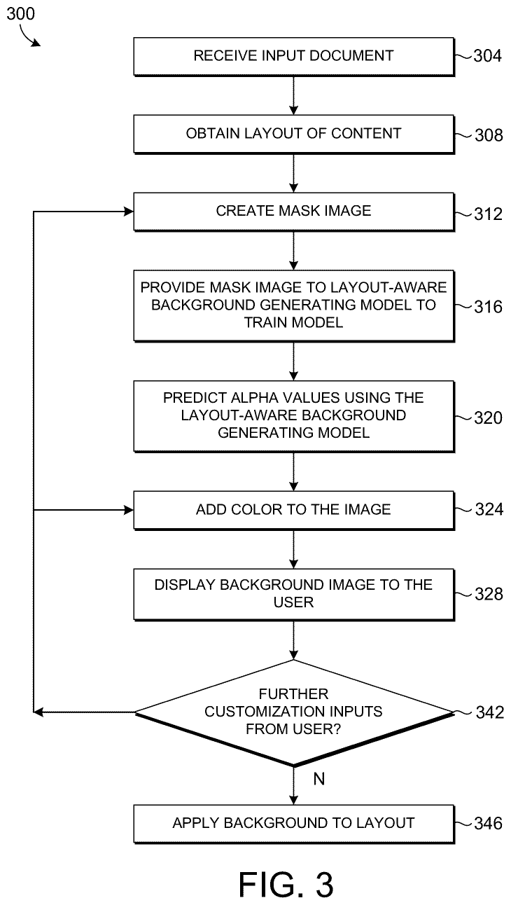

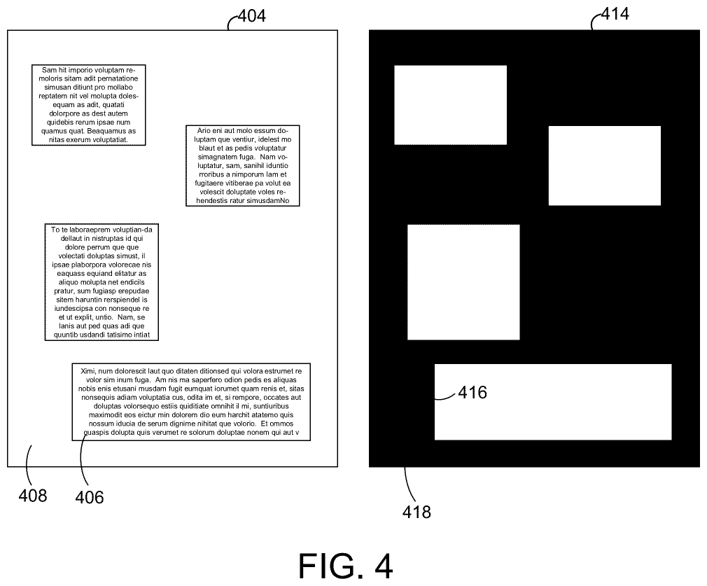

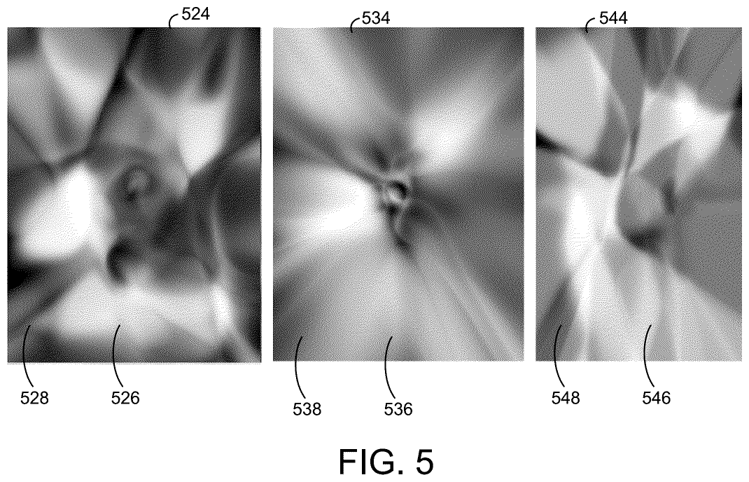

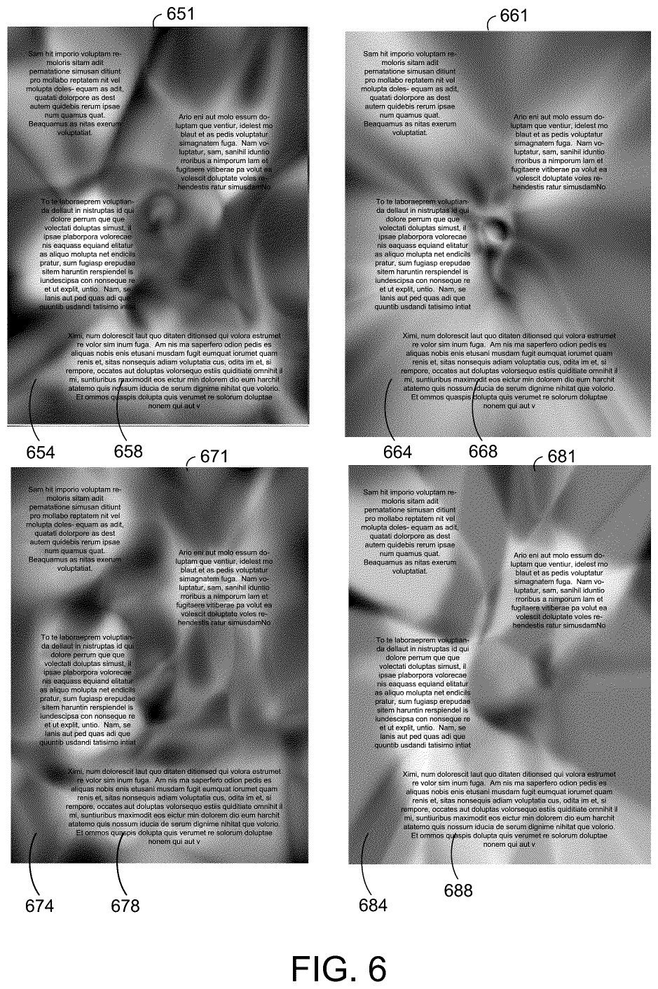

With reference to FIG. 3, FIG. 4, FIG. 5, and FIG. 6, FIG. 3 is a flow diagram illustrating an exemplary method 300 for facilitating generation of layout-aware backgrounds in accordance with one embodiment of the present disclosure. FIG. 4, FIG. 5, and FIG. 6 provide images illustrative of aspects described herein. A processing device such as a user device, a server, a cloud computing service or the like implements the exemplary method 300. The layout-aware background generating system can initiate the method 300 to generate a layout-aware background as described herein.

As shown in FIG. 3, in one embodiment, at block 304, a layout-aware background generating system receives an input layout. The input document can be any document that may or may not include any content (for e.g. pdf document, word document, image, website, social media page, or the like). Contents in a document include, but are not limited to, images, text, symbols, or the like. If the input document includes contents, the arrangement of the regions requiring visibility form a layout of content in the input document. The regions requiring visibility are the regions on which the layout-aware background generating system will provide more transparency when generating the background. This allows for more visibility of the content allowing for easier readability of the content in those regions when the background image is generated. The regions requiring visibility may include regions or groups of areas of content. As such, the manner in which the regions requiring visibility are set out in a document or in pages in a document form a layout of content in the input document. The regions of the document can include coordinates of regions in the document such as x,y coordinates or can use any method to specify the locations of the regions requiring visibility. In some embodiments, the layout of content can include a portion of the content. For example, if a document has an image that is irrelevant such as a border around the page, then the layout-aware background generating system will not include the border image in the layout of content. In some embodiments, a region of visibility can include areas of the document without any content. For example, a region of visibility in the document can be a circle that does not include any content but is a region that the layout-aware background generating system will provide transparency over. In another example, the region of visibility can include an offset from the content. The offset can allow the layout-aware background generating system to create more of a transparency in the region so that the background generated creates more of a transparency in that area. In some embodiments, different regions in the document or layout could indicate different levels of visibility requirement. For example, in the regions that include a border around a page in the document could require a lower visibility and regions that include text in the document could require a higher visibility.

In some embodiments, the layout-aware background generating system, at block 308, obtains the layout of content. The layout-aware background generating system can obtain the layout of content from a software such as Adobe® Indesign®. In other embodiments, the layout-aware background generating system can obtain the layout of content by analyzing and reviewing the document and obtaining the regions of document. In one example, the layout-aware background generating system analyzes a document and generates bounding boxes around regions requiring visibility. For example, the layout-aware background generating system generates a rectangle surrounding regions requiring visibility. The bounding boxes can specify the position of the boxes in the document. All the bounding boxes form a layout in the document. It should be understood that the bounding boxes can be of any other shape such as a circle around the region of text or a polygon around the region of text or a 2D or 3D shape having one or more curved lines surrounding the regions requiring visibility or the like. With further reference to FIG. 4, image 404 illustrates an exemplary document that is input at block 304. The layout-aware background generating system obtains the layout of content that is shown by the bounding boxes 406 around the text. In some embodiments, the region outside of the bounding boxes 406 do not include content.

Turning to FIG. 3, the layout-aware background generating system, at block 312, creates a mask image. In one embodiment, the mask image is based on the layout of image obtained at block 308. In another embodiments, the mask image can be obtained from a user or specified by a user. In some embodiments, the mask image includes black and white regions. The white region corresponds to the regions requiring visibility in the document and the black regions are regions that do not have regions on content. In some embodiments, the white region corresponds to regions requiring visibility where the background generated by the system will be more transparent and the black region correspond to regions where the background generated by the system will be less transparent. In some embodiments, the black regions can include areas of content that are of lower importance and do not require a higher visibility through the generated background. The black regions in the mask image can be referred to as the background regions and the white regions in the mask image can be referred to as the foreground regions. In one embodiment, the mask image designates the regions requiring visibility as white regions and the area of the document outside those regions as black regions. Any other value, color, or designation system can be used to designate the different regions in the mask image.

With further reference to FIG. 4, image 414 illustrates an exemplary mask image created at block 312. The mask image 414 has white regions corresponding to regions requiring visibility 406 seen in image 404. The areas outside of the regions requiring visibility 406 are black. It should be understood that while the mask image is black and white in some embodiments, in other embodiments, it can be of any contrasting color or the regions include different weights or values that allow the layout-aware background generating system to differentiate between the level of importance of the regions 406, 408 such that regions of higher importance will be provided with a higher level of transparency and regions of lower importance will be provided with a lower level of transparency.

In one example, a region of visibility with a higher importance has a higher value and a region of visibility with a lower importance has a lower value. In one example, the layout-aware background image generating model predicts transparency for certain regions of the image. For example, the layout-aware background image generating model predicts the RGB values for the foreground regions as complete black and the RGB values of the background regions as complete white. Therefore, in areas where the alpha value is 0 (indicating complete transparency), the final generated background image looks white in areas where the alpha value is 1 and the final generated background image looks between a shade of black to greyish where the alpha value is between 0 and 1.

In another example, the layout-aware background image generating model predicts a larger amount of pixels that are white in a region for areas of a higher importance and predicts lesser amount of pixels that are white for areas of lower importance. In one example, the layout-aware background image generating model predicts more white pixels for areas of a higher importance and predicts any shade of black, white, or gray for areas of lower importance.

The mask image 414 was generated using an InDesign® application. In InDesign®, the current artboard for which the mask has to be created was first cloned as a hidden artboard in a different document. In order to create the black background 418 for the mask image 414, a rectangular object with the same dimensions of the artboard was created. It was placed at the lowest z-index. The lowest z-index refers to the bottom most object in the visual layers of design. The rectangular object was then colored black using the InDesign application. In order to create the white regions 416, the content of the objects on the artboard was removed thereby leaving the objects wireframes only. The objects were stroked and filled with white color. To create the final mask image 414, the artboard with black background and white objects was exported to JPG as a grayscale image. It should be understood that any other software or application can be used to create a mask image such as image 414.

In some embodiments, machine learning (ML) methods can be used to create a mask image 414. For example, the layout-aware background generating system can use ML methods to automatically extract regions requiring visibility or the location of the regions requiring visibility from a document and automatically create a mask image based on the locations of regions requiring visibility. In some embodiments, a user or a system provides a desired mask image. For example, a user can use a software to indicate areas in the document that require visibility and provide that to the layout-aware background generating system or rates different areas in the document in the order of level of visibility needed. For example, areas of high visibility are rated 10 and placed around a bounded box and areas of lower visibility are rated 1 and placed around a bounded box. The layout-aware background generating system then generates a mask image based on the user's preferences.

The layout-aware background generating system at block 316 provides the mask image to a layout-aware background generating model to generate a background image. This model can be a Machine Learning (ML) model. The layout-aware background generating model can use any algorithm or software application to generate a background image. In one embodiment, the layout-aware background generating model uses a modified Compositional Pattern Producing Neural Nets (CPPN) Machine Learning (ML) network to generate a background image. In one embodiment, the CPPN network can be the image generator. A CPPN network is a collection of randomly initialized neural networks. A modified CPPN network uses a function, c=f(x, y), that defines the intensity of the image for every point in space. This allows the modified CPPN network to generate very high resolution images when the function c=f(x, y) is called to obtain the color or intensity of every pixel, given that pixel's location. The function used in the modified CPPN network, c=f(x, y), can be built from many mathematical operations. It can also be represented by a neural network, with a set of weights (w) connecting the activation gates that will be held constant when drawing an image. So the entire image can be defined as a function f (w, x, y), where w (weight), x, and y (coordinates) are variables for function f. The CPPN network model receives inputs that can include the x and y coordinates for a pixel. It can further receive distance from a center (referred to as variable r). Variable r refers to the distance from a center in order to provide a symmetric image. It can also receive another variable z as an input. Variable z refers to a latent vector that can provide an image with subtle different compared to another image using a different z parameter. More details of the inputs r and z are discussed herein The CPPN model includes one or more blocks with different functions that can be used in the CPPN model such as a sigmoid/logistic activation function, Tanh function, ReLU function, cosine, sine or the like. Employing different combination of functions at the CPPN model blocks can provide unique and exotic looking images. It should be understood that the modified CPPN can use any type of architecture with any number of blocks and any value for radius r and latent vector z.

In the modified CPPN network, the function f(x,y) returns either a single number between zero and one that defines the transparency of the image at that point. This assists in creating a Red Green Blue Alpha (RGBA) image. The actual Red Green Blue (RGB) values could be random or can be inspired from the document. For example, the RGB colors can be based on the colors used in the input document for which a layout-aware document is being generated. In the modified CPPN network, a radius term for each pixel is provided. The radius term r is defined as r=sqrt{x\hat{ }2+y\hat{ }2}, so the modified CPPN network function will be f(w, x, y, r). The weights w of the neural network will be initialized to a random value from the unit Gaussian distribution.

An additional input z 504 is also provided to the modified CPPN network. The input z is also referred to as a latent vector. The latent vector z is a vector of a n number of real numbers. The number n is generally much smaller than the total number of weighted connections in the network Therefore, the generative network is defined as a function f(w, z, x, y, r). By modifying the values of z, the modified CPPN network can generate different images. The entire space of images that can be possibly generated by the modified CPPN network by modifying the z values can be referred to as the latent space. In one example, z can be interpreted as a compressed description of the final image, summarized with n real numbers. If z is modified by a small amount, the output image would also change around only slightly since the network is a continuous function. Therefore by providing a slight different z value, the image in a latent space can slowly morph into another image in the same latent space by generating images with a latent vector z that gradually moves from z1 to z2. By slightly modifying the z values, the images generated are similar by slightly different and can be combined to create a video. Since a video can be created using 24 images by playing back the images at 24 fps (frames per second) so that in each second, the video shows 24 still images developed by the modified CPPN network using slightly different values of z. Therefore, the background can consist of a video of slightly changing background created by at least 24 images created using the modified CPPN network by slightly changing the z value.

In the modified CPPN network, the weights are initialized to random values. In one example, the weights can be sampled from a Gaussian distribution N with a mean of zero and with a variance dependent on the number of input neurons and a parameter R which can be adjusted based on user's preference. The random number generator used for the Gaussian distribution can always produce the same values for the same seed. Therefore, the same particular seed can be used to retrieve exactly the same result. Even though a distinct and unique images for a particular seed value is generated to initialize the weights, the same result can be reproduced using the same seed and mask image. Alternatively, in some embodiments, the seed value can be destroyed to ensure that the particular seed is never used again so that every image is unique. This can be used for publishing the generated artworks such as Non-Fungible Tokens (NFTs) and cryptographic digital assets.

The layout-aware background generating model containing a modified CPPN network is trained using the mask image. If the mark image contains black and white regions where the foreground regions are white and the background regions are black, the pixel intensity for the mask image will vary from 0 to 255, where 0 refers to black and 255 refers to white. The pixel value from 0 to 255 is normalized so that it is in the range of 0 to 1. Therefore, the value of foreground pixels will be 1 (since grayscale value of white is 255) and the value for background pixels will be 0 (since grayscale value of black is 0).

In one embodiment, the layout-aware background generating model is trained with the mask image because the layout-aware background system prefers that the modified CPPN network should output values closer to 1 for foreground regions and allow any value between 0-1 for background regions. This allows the generated images to have less intense values at foreground regions while allowing any random value at the background region. As noted in FIG. 5, FIGS. 525, 534, 544 are generated backgrounds. In the white foreground regions 526, 536, 546, it is preferred to keep them black. For example, the modified CPPN predicts the RGB values for the foreground regions as complete black and the RGB values of the background regions as complete white. In one example, the foreground regions are preferred to be transparent which translated to an alpha value of zero (0). Therefore, in areas where the alpha value is 0 (indicating complete transparency), the final generated background image looks white in areas where the alpha value is 1 and the final generated background image looks between a shade of black to greyish where the alpha value is between 0 and 1. In one example, if the RGB foreground is black and the RGB background is white and the RGBA is converted to RGB can lead to an image as seen in FIG. 4. In the background regions 528, 538, 548, they can be any value from 0-1. Some pixels in regions 528, 538, 548 are black, some are different shades of gray in color, and some are white. To train the model to generate such a background, a loss function that can penalize the model when it outputs any value apart from 1 for foreground regions (526,536,546 corresponding to 416) and doesn't penalize the model at all when it outputs any value between 0-1 in the background regions (528, 538, 548 corresponding to 418). The standard Root Mean Square (RMS) loss function for the i th input looks like:

Loss(i)=(sqrt((Y*(i))\hat{ }2−(Y(i))\hat{ }2))/N Equation (4)

Where, Y refers to the actual pixel value in the mask image for the ith pixel in the mask image, Y* refers to the pixel value predicted by the layout-aware background generating model, and N is the total number of input samples.

In the modified CPPN network, the modified RMS loss function is:

Loss(i)=((sqrt((Y*(i))\hat{ }2−(Y(i))\hat{ }2))/N)*Y(i) Equation (5)

Where, Y refers to the actual pixel value in the mask image for the ith pixel in the mask image, Y* refers to the pixel value predicted by the layout-aware background generating model, and N is the total number of input samples. To achieve the desired loss function, the RMS loss function is multiplied with the actual value of the pixel (Y). This is because each element in the pixel Y contains only 2 possible values: 0 or 1. Therefore, for foreground regions (526,536,546 corresponding to 416), the value will be 1 and hence the loss will remain the same. However, for background regions (528, 538, 548 corresponding to 418) the value of Y will be 0 and hence the loss will become 0. When the loss is 0, the model will not be penalized for any prediction for background pixels. It should be understood that the loss function could be changed from RMS to any other standard loss function as well.

Turning to FIG. 4 and FIG. 5, the images 524, 534, 544 illustrate the background images in grayscale. As illustrated in images 524, 534, 544, the generated background images 524, 534, 544 have provided a transparent area for the foreground regions 526, 439, 546 corresponding to the white regions 416 in the mark image 414 to allow the content in the foreground regions 526, 439, 546 to be more visible and has created unique color combinations for the background regions 528, 538, 548 corresponding to the black background region 418 in the mask image 414.

The layout-aware background image can be generated after multiple iterations through the model. Multiple iterations allow the model to generate a layout-aware background image that is close to the mask image. For example, after multiple iterations through the model, the layout-aware background image starts to look similar to the mask image where the regions requiring visibility in the document are almost similar to the regions requiring visibility in the mask image. For example, image 524 was generated after many iterations through the model since the white regions are looking close to the mask image 414. For example region 526 of image 524 looks similar to region 416 of the mask image compared to region 546 of the image 544. Image 544 was generated after less iterations through the model as compared to image 524. The region 546 of image 544 contains more pixels that are not white compared to region 526 of image 524. Since the network can be continuous and differentiable, sampling the network on two different very close points leads to a very similar output value. This can ensure that there is no sudden transitions between foreground and background regions and the resulting images have very smooth transitions. Turning to FIG. 6, the output background images when combined with the content 658, 668, 678, 688 of the document show the background images in grayscale. As illustrated in images 651, 661, 671, 681, the generated background images have provided a transparent area for the foreground regions 658, 668, 678, 688 to allow the content in the foreground regions 658, 668, 678, 688 to be more visible. The background regions 654, 664, 674, 684 have a mixed white, gray, and black shades. The layout-aware background generating model has generated a transparency for the foreground regions 658, 668, 678, 688 while making the transitions smooth between the foreground regions 658, 668, 678, 688 and background regions 654, 664, 674, 684. It should be noted that some foreground regions such as 678 contain darker background than would be preferred. One method of creating a greater transparency in the foreground region is by providing a larger offset around the foreground regions in the mask image. This allows the model more space around the foreground region to smoothly transition from foreground regions to background regions. Another method of creating a greater transparency in the foreground region is by penalize the model more heavily for foreground regions. For example, the loss function can be multiplied with a positive constant. As such, the loss for not predicting one (1) in the foreground region will increase while the loss for background region will remain same. A higher loss can result in the model being more sensitive and the model will try and predict one (1) in the foreground regions more aggressively.

Continuing with FIG. 3, layout-aware background generating system at block 320 predicts the alpha values from the layout-aware background generating model. The layout-aware background generating system subtracts the final value predicted by the model from one (1) from each pixel since less intense values are preferred around the foreground regions 458, 468, 478, 488. An alpha value of one (1) represents an opaque pixel and an alpha value of zero (0) represents a transparent pixel. If the system predicted a value of one for a certain area in the foreground region and the system would like that area to be completely transparent, the system will subtract the prediction value from one (1) to get the alpha value. The value predicted by the system is a measure of transparency—1 meaning we want the region to be transparent and 0 meaning we want the region to be opaque. We subtract this value from 1 to get the actual alpha value. This value is then multiplied with 255 to get into the Alpha channel range. This can be used to add transparency to an RGB image creating an RGBA layout-aware background image using Red Green Blue (RGB) values. In one example, a pixel with an alpha value of one allows the pixel to be opaque and a pixel with an alpha value of zero allows the pixel to be transparent. For example, a pixel with an alpha value of one allows the pixel to be completely opaque and a pixel with an alpha value of zero allows the pixel to be completely transparent. When pixels in an image are transparent, the background pixels or colors show through in regions where the pixel has alpha value of 0 (zero). In order to add a particular colored background to the RGBA image using equations (1)-(3) can be used. In one example, after adding a particular colored background to an RGBA image, the RGBA image is converted into a simple RGB image or an RGBA image with alpha value of 1 (one) at every pixel location. In another example, after adding a particular colored background to an RGBA image, the RGBA image is converted into a simple RGB image or an RGBA image with alpha value of 1 (one) at some pixel locations,

The RGB values could either be random, or could be inspired from context or demographic or time of day or could be directly inputted by the user. For example, the layout-aware background generating system can determine the context in the document refers to Christmas day and therefore changes the RGB colors to match a green color for the foreground region and a red color for the background region. In another example, the layout-aware background generating system determines the current time of day for a user is day time and changes the colors to more contrasting shades than would be used for the document being viewed by the user at night. In another example, the document evaluates that the content of the document is business and modifies the colors to match the tones of a business document and avoids loud colorful shades. In another example, the layout-aware background generating system can determine the demographic of the user or even the location of the user and modify the colors used based on that. For example, if the document is viewed by a user in Brazil or Thailand, the layout-aware background generating system may avoid using the color purple which is considered a color for mourning and sometimes considered unlucky.

In some embodiments, the layout-aware background generating system can generate a background image using two colors instead of just one color. For example, the foreground region can be of one color and the background regions can be of a different color. The RGBA images are converted to RGB images so that the images do not have a transparency layer. The conversion from RGBA to RGB can be performed using the equations (1)-(3).

Where Source is the generated image in a RGBA, BGColor is the color chosen as background for the image, Target is the final image in RGB format. R stands for red, G stands for Green, B stands for Blue, A stands for Alpha.

The equations (1), (2), and (3) allow the generation of images with 2 colors. This can be done by choosing the RGB values of background color instead of using black or white value for that. A background image color can be used from the context as well or a background color can be chosen that has high contrast value from foreground text to improve the readability of text. Different techniques such as color harmony or the color wheel can be used to get the suitable or complimentary colors. Additionally or alternatively, both the colors can be customized manually by the user.

One embodiment of the present disclosure includes a method comprising obtaining a mask image based on a layout of content in a document, the mask image having a content area corresponding to content of the document, training a machine learning model using the mask image to provide a trained machine learning model that generates transparency values for pixels of a background image for the document; and minimizing, during training, a difference between values for pixels in the content area of the mask image and the transparency values for pixels of the background image corresponding to the content area of the mask image using a loss function. The method can further include receiving user input modifying the mask image to provide a modified mask image and retraining the trained machine learning model using the modified mask image. The method can further include generating, using the machine learning model, the transparency values for the background image, determining color values for the pixels of the background image, and generating the background image using the transparency values and the color values. The machine learning model can be trained using the mask image for a single iteration. The mask image can include a foreground region corresponding to the content area in the document and a background region corresponding to an area in the document without content. Pixels in the foreground region have a value of one and pixels in the background region have a value of zero. The training the machine learning model comprises using a loss function that encourages the machine learning model to generate a transparency value of one (therefore, the alpha value is zero) for pixels of the background image corresponding to the foreground region and randomly generate a value for pixels of the background image corresponding to the background region. In one example, the loss function includes a modified root mean square function.

One embodiment the present disclosure includes one or more non-transitory computer storage media storing instructions that, when executed by one or more processors, cause the one or more processors to perform operations comprising generating, using a machine learning model trained on a mask image corresponding to a document, transparency values for pixels of a background image for the document, determining color values for the pixels of the background image and generating the background image using the transparency values and the color values. The operations can further include receiving user input modifying the color values to provide modified color values and modifying the background image using the modified color values. In some examples, the color values for the pixels can be randomly selected. In some examples, the color values for the pixels can be determined based on at least one of user demographic, time of day, season, and content in the document. In some examples, the color values for the pixels can be determined based on user input. Generating the background image using transparency values can include converting the transparency values to alpha channel values, wherein the background image is generated using the alpha channel values and the color values. Converting the transparency values to alpha channel values can include subtracting the transparency value from one to obtain a subtracted value for each pixel and multiplying the subtracted value with 255 to provide the alpha channel value for each pixel.

One embodiment of the present disclosure includes a computer system comprising a memory device and a processing device, operatively coupled to the memory device, to perform operations comprising receiving a training dataset comprising a document, creating a mask image, the mask image having a content area corresponding to content of the document, training a machine learning model using the mask image to provide a trained machine learning model that generates transparency values for pixels of a background image for the document, and minimizing, during training, a difference between values for pixels in the content area of the mask image and the transparency values for pixels of the background image corresponding to the content area of the mask image using a loss function. The operations can further include receiving user input modifying the mask image to provide a modified mask image and retraining the trained machine learning model using the modified mask image. Each pixel in the content area of the mask image can have a value of one, and each pixel in at least one other area of the mask image without content can have a value of zero. In the mask image, the value denotes the color of the pixel, therefore the value will be 255 for white and 0 for black. When that value is divided by 255, a value between 0 and 1 can be obtained. For example, a 1 for white and 0 for black. The loss function can include a modified root mean square function.

Having described implementations of the present disclosure, an exemplary operating environment in which embodiments of the present technology may be implemented is described below in order to provide a general context for various aspects of the present disclosure. Referring to FIG. 6, an exemplary operating environment for implementing embodiments of the present technology is shown and designated generally as computing device 700. Computing device 700 is but one example of a suitable computing environment and is not intended to suggest any limitation as to the scope of use or functionality of the technology described herein. Neither should the computing device 700 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology described herein may be practiced in a variety of system configurations, including hand-held devices, consumer electronics, general-purpose computers, more specialty computing devices, etc. The technology described herein may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user and/or system or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user and/or system interface (NUI) that processes air gestures, voice, or other physiological inputs generated by a user and/or system. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion.

Aspects of the present technology have been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present disclosure are described with reference to a distributed computing environment; however, the distributed computing environment depicted herein is merely exemplary. Components can be configured for performing certain embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method comprising:
receiving a training dataset comprising a document;
obtaining a mask image based on a layout of content in the document, the mask image having a content area corresponding to content of the document; and
training a machine learning model using the mask image to provide a trained machine learning model that generates transparency values for pixels of a background image for the document.

2. The method of claim 1, wherein the mask image includes a foreground region corresponding to the content area in the document and a background region corresponding to an area in the document without content.

3. The method of claim 1, wherein the background image is used in at least one of a cryptographic digital assets and a video.

4. The method of claim 2, wherein pixels in the foreground region have a value of one and pixels in the background region have a value of zero.

5. The method of claim 4, wherein the training the machine learning model comprises using a loss function that encourages the machine learning model to generate a transparency value of one for pixels of the background image corresponding to the foreground region and randomly generate a value for pixels of the background image corresponding to the background region.

6. The method of claim 5, wherein the loss function comprises a modified root mean square function.

7. The method of claim 1, further comprising:
receiving user input modifying the mask image to provide a modified mask image; and
retraining the trained machine learning model using the modified mask image.

8. The method of claim 1, further comprising:
generating, using the machine learning model, the transparency values for the background image;
determining color values for the pixels of the background image; and
generating the background image using the transparency values and the color values.

9. The method of claim 1, further comprising:
minimizing, during training, a difference between values for pixels in the content area of the mask image and the transparency values for pixels of the background image corresponding to the content area of the mask image using a loss function.

10. One or more non-transitory computer storage media storing instructions that, when executed by one or more processors, cause the one or more processors to perform operations comprising:
generating, using a machine learning model trained on a mask image corresponding to a document, transparency values for pixels of a background image for the document;
determining color values for the pixels of the background image; and
generating the background image using the transparency values and the color values.

11. The one or more non-transitory computer storage media of claim 10, wherein the color values for the pixels are randomly selected.

12. The one or more non-transitory computer storage media of claim 10, wherein the color values for the pixels are determined based on at least one of user demographic, time of day, season, and content in the document.

13. The one or more non-transitory computer storage media of claim 10, wherein the color values for the pixels are determined based on user input.

14. The one or more non-transitory computer storage media of claim 10, further comprising receiving user input modifying the color values to provide modified color values; and
modifying the background image using the modified color values.

15. The one or more non-transitory computer storage media of claim 10, wherein generating the background image using the transparency values comprises:
converting the transparency values to alpha channel values, wherein the background image is generated using the alpha channel values and the color values.

16. The one or more non-transitory computer storage media of claim 10, wherein converting the transparency values to alpha channel values comprises:
subtracting the transparency value from one to obtain a subtracted value for each pixel; and
multiplying the subtracted value with 255 to provide the alpha channel value for each pixel.

17. A computer system comprising:
a memory device; and
a processing device, operatively coupled to the memory device, to perform operations comprising:
receiving a training dataset comprising a document;
creating a mask image, the mask image having a content area corresponding to content of the document; and
training a machine learning model using the mask image to provide a trained machine learning model that generates transparency values for pixels of a background image for the document.

18. The computer system of claim 17, wherein each pixel in the content area of the mask image has a value of one, and wherein each pixel in at least one other area of the mask image without content has a value of zero.

19. The computer system of claim 17, wherein the loss function comprises a modified root mean square function.

20. The computer system of claim 17, further comprising:
receiving user input modifying the mask image to provide a modified mask image; and
retraining the trained machine learning model using the modified mask image.
